(19) United States
(12) Patent Application Publication
(10) Pub. No.: US 2014/0121872 A1
(43) Pub. Date: May 1, 2014

(54) METHOD FOR PREVENTING ABNORMAL VIBRATION OF HYBRID VEHICLE

(71) Applicant: HYUNDAI MOTOR COMPANY, Seoul (KR)

(72) Inventors: Wan Soo Oh, Hwaseong-si (KR); Heung Seok Lee, Hwaseong-si (KR); Jae Woong Hwang, Hwaseong-si (KR)

(73) Assignee: Hyundai Motor Company, Seoul (KR)

(21) Appl. No.: 13/712,199

(22) Filed: Dec. 12, 2012

(30) Foreign Application Priority Data
Oct. 30, 2012 (KR) 10-2012-0121424

(51) Int. Cl. B60W 20/00

(52) U.S. Cl. CPC B60W 20/00
USPC 701/22; 180/65.275; 903/902

(57) ABSTRACT

A method prevents an abnormal vibration of a hybrid vehicle. In the method, information is inputted into an engine management system (EMS) by sensing an engine rpm, a transmission rpm, a gear shift, a signal of an accelerator pedal sensor (APS), and an engine torque. It is determined whether or not a current engine rpm and a current engine torque fall within a predetermined rpm and damper reflection torque range that is a range of abnormal vibration occurrence. The engine torque and a motor torque are mutually corrected when the current engine torque falls within the range of the abnormal vibration occurrence. Here, the abnormal vibration is prevented by avoiding an inflection point of a damper at a resonance point of a driving system while maintaining a total driving torque.

### CROSS-REFERENCE TO RELATED APPLICATION

The present application claims priority of Korean Patent Application Number 10-2012-0121424 filed Oct. 30, 2012, the entire contents of which application is incorporated herein for all purposes by this reference.

### BACKGROUND OF INVENTION

1. Field of Invention

The present invention relates to a method for preventing an abnormal vibration of a hybrid vehicle. More particularly, the present invention relates to a method for preventing an abnormal vibration of a hybrid vehicle, which can prevent occurrence of an abnormal vibration at a resonance rpm of a driving system of in a hybrid vehicle and an inflection point of a damper of an engine clutch.

2. Description of Related Art

Generally, a power train of a hybrid vehicle drives the vehicle by delivering driving forces of an engine and a motor to a transmission.

FIG. 1 is a view illustrating a power train of a hybrid vehicle according to a typical method. When an engine clutch 1 is locked up (lock up; connected state), driving forces generated in an engine 2 and a motor 2 are delivered to a drive shaft 5 through an transmission 4, and are distributed to both wheels through a differential gear 6.

The engine clutch 1 includes a first disk 1 a connected to the engine 2, a second disk 1b connected to the motor 3, and a first and a second damper 7a and 7b. The first and the second dampers 7a and 7b are disposed in one or both of disks 1a and 1b in the rotation direction, formed in a spring shape with different spring constants, and disposed overlapping at the inside and outside thereof.

When the engine clutch 1 is locked up, the first disk la and the second disk lb contact each other to generate a torque in the engine 2 and the motor 3. The torque is delivered to the transmission 4.

While the first and the second dampers 7a and 7b is compressed in the rotation direction, they serve to absorb a torsional torque generated upon frictional contact of the first disk and the second disk 1a and 1b.

In this case, the first and the second damper 7a and 7b have different spring constants. For example, FIG. 3 is a graph illustrating a torsional torque according to a torsional angle of a damper having two-step stiffness. The first damper 7a has a low stiffness, and can absorb a small torsional torque in the wide range of torsional angle. On the other hand, the second damper 7b has a high stiffness, and can absorb a large torsional torque in the narrow range of torsional angle.

Here, the motor 3 receives power from the battery 8 to generate a uniform torque. On the other hand, since the engine 2 generates a torque by periodic explosive force in the cylinder, the magnitude of the torque is not uniform and a vibration occurs.

Accordingly, when the engine clutch 1 is locked up, an excitation force is not generated in the motor 3, but an excitation force is generated in the engine 2 to be delivered to the transmission 4.

On the other hand, when a certain condition is met in the driving system of the vehicle due to the excitation force of the engine 2, an abnormal vibration occurs.

The abnormal vibration occurs at the boundary range (inflection point) between the first stiffness (low stiffness) and the second stiffness (high stiffness) of the damper 7 when a resonance rpm of the driving system (engine 2, motor 3, transmission 4, drive shaft 5, differential gear 6, and wheel) is, for example, 1800 rpm to 2000 rpm.

In other words, when the engine torque passes through the resonance rpm range of the driving system and around the inflection point of the damper stiffness, the abnormal vibration occurs, reducing Noise, Vibration, and Harshness (NVH) performances.

In order to solve this limitation, when the engine torque passes from the resonance rpm range to the stiffness inflection point Nm of the damper, a method for insulating the engine torque can be used.

However, the method for insulating the engine torque causes discontinuity of driving such as interruption.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention provides a method for preventing an abnormal vibration of a hybrid vehicle, which can prevent an abnormal vibration while maintaining continuity of the total driving torque by avoiding an inflection point of damper stiffness at a resonance point of a driving system through control of an engine and a motor that are characteristics of the hybrid vehicle.

In one aspect, the present invention provides a method for preventing an abnormal vibration of a hybrid vehicle, including: inputting information into an engine management system (EMS) by sensing an engine rpm, a transmission rpm, a gear shift, a signal of an accelerator pedal sensor (APS), and an engine torque; determining whether or not a current engine rpm and a current engine torque fall within a predetermined rpm and damper reflection torque range that is a range of abnormal vibration occurrence; and mutually correcting the engine torque and a motor torque when the current engine torque falls within the range of the abnormal vibration occurrence, wherein the abnormal vibration is prevented by avoiding an inflection point of a damper at a resonance point of a driving system while maintaining a total driving torque.

In various embodiments, the correcting of the engine torque and the motor torque may include determining whether or not the current engine torque is equal to or greater than the predetermined damper inflection torque; and reducing the motor torque and increasing the engine torque when the current engine torque is greater than the predetermined damper inflection torque, or reducing the engine torque and increasing the motor torque when the current engine torque is equal to or smaller than the predetermined damper inflection torque.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a power train of a hybrid vehicle according to a related art.

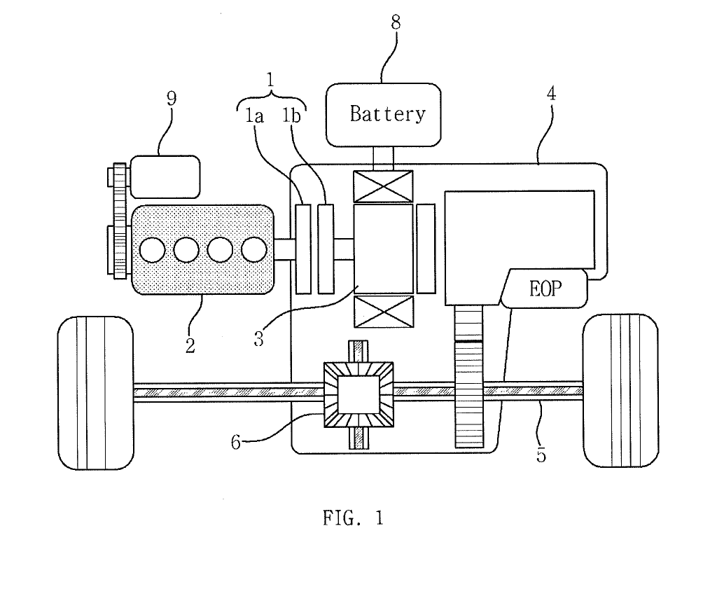

FIG. 2 is a view illustrating an engine clutch of FIG. 1 equipped with a two-step stiffness damper.

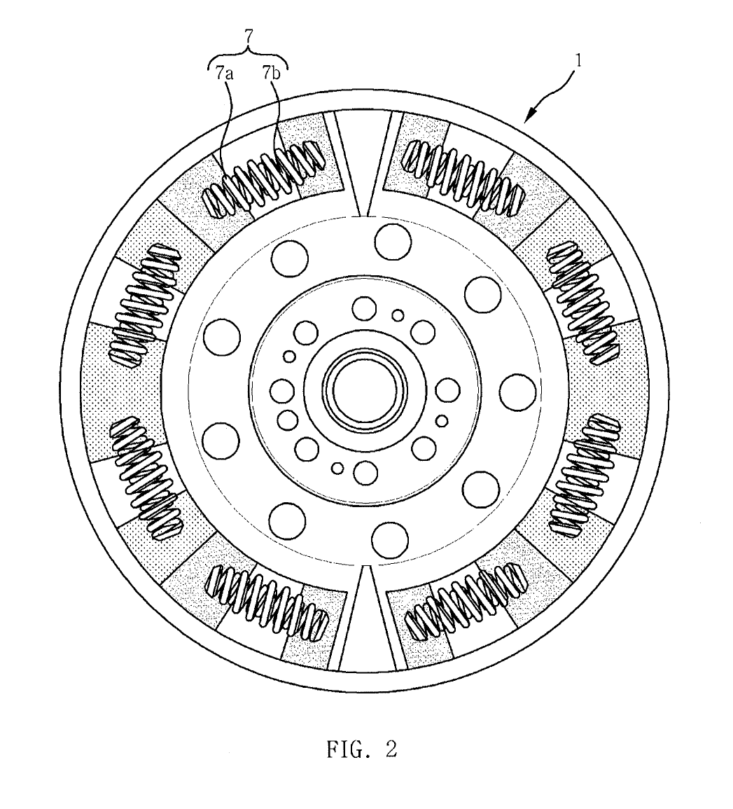

FIG. 3 is a graph illustrating an inflection point of a two-step stiffness damper in the range of the abnormal vibration occurrence according to a related art.

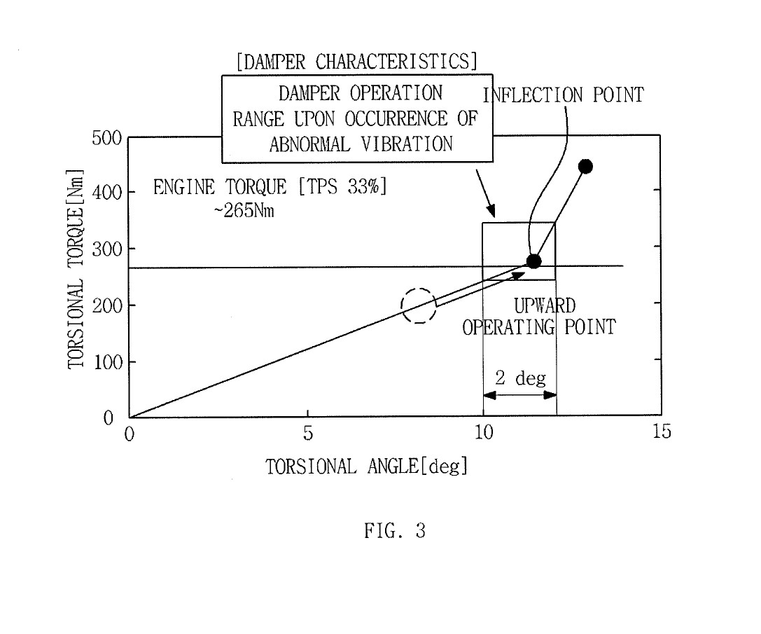

FIG. 4 is a view illustrating an exemplary principle according to the present invention.

FIG. 5 is a flowchart illustrating an exemplary method for preventing an abnormal vibration of a hybrid vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

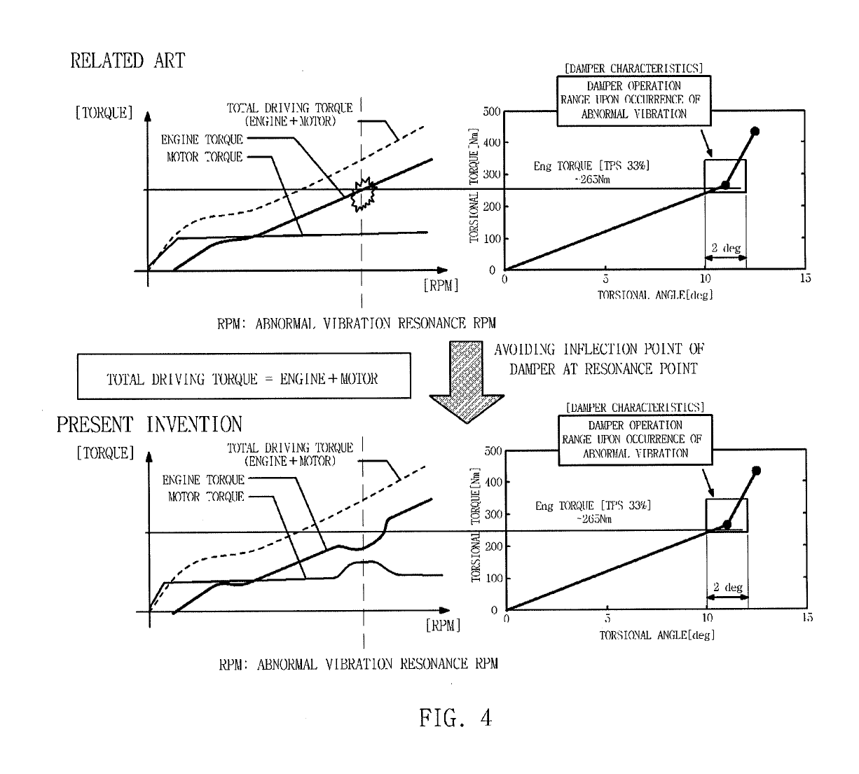

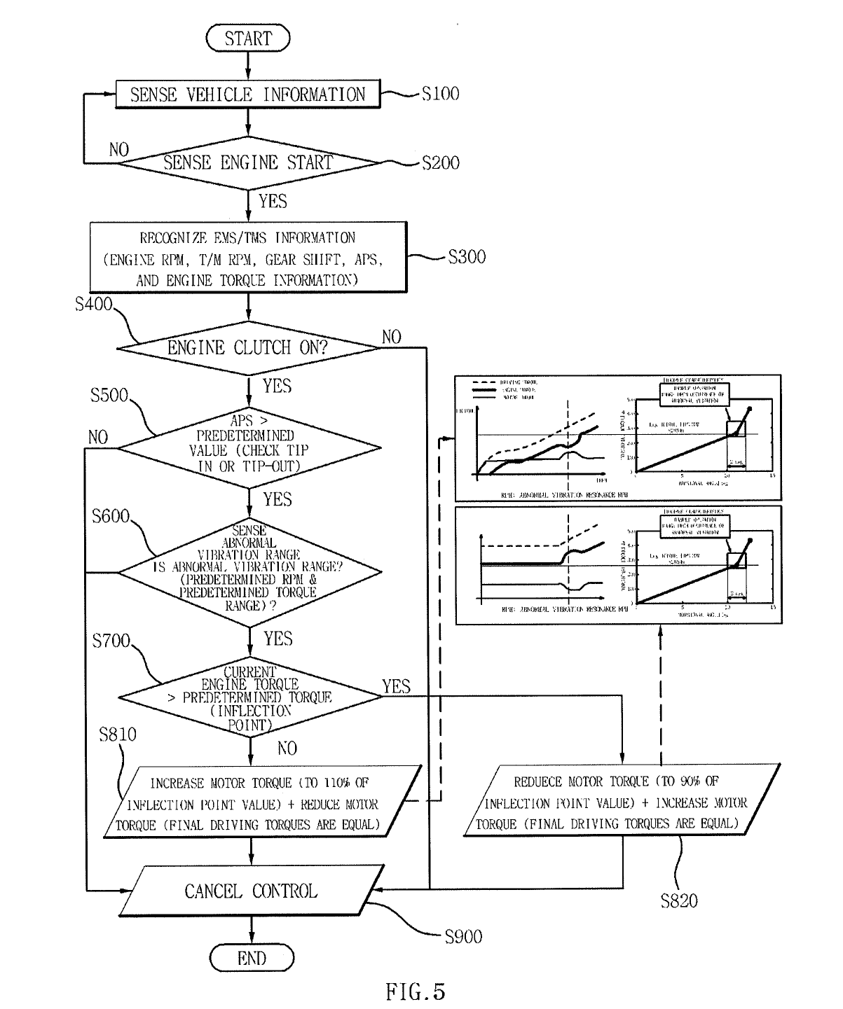

FIG. 4 is a view illustrating the principle according to various embodiments of the present invention. FIG. 5 is a flowchart illustrating a method for preventing an abnormal vibration of a hybrid vehicle according to various embodiments of the present invention.

The present invention relates to method for preventing an abnormal vibration of a hybrid vehicle, which can prevent the abnormal vibration while maintaining continuity of driving.

Various embodiments of the present invention may be a logic, which can prevent an abnormal vibration by avoiding the inflection point of damper stiffness through control of the engine and the motor that is characteristics of the hybrid when the engine torque passes the range of abnormal vibration occurrence

The abnormal vibrations can be completely prevented while continuity of total driving torque being maintained by setting the resonance rpm of abnormal vibration and inflection torque of damper when mapping an Engine Management System (EMS), and performing mapping of correction of the engine torque and motor torque when the engine torque passes the range of the abnormal vibration.

The method for preventing an abnormal vibration of a hybrid vehicle will be will be described as follows.

First, before the engine starts, vehicle information may be sensed (S100).

Next, it may be sensed whether or not the engine starts (S200).

The engine startup can be performed by various methods using an ignition key, a smart key, etc. according to the type of vehicles. When the startup switch turns on, the EMS can perform the engine start by controlling the startup motor, and sense the engine start.

Next, when the engine start is sensed, the EMS/TMS (transmission system) information such as an engine rpm, a transmission rpm, a gear shift, an accelerator pedal sensor (APS), and engine torque information may be sensed (S300).

Next, it may be determined whether or not the engine clutch turns on (S400).

Thereafter, when the engine clutch turns off, since abnormal vibration does not occur, the control according to various embodiments of the present invention may be cancelled (S900).

Next, when the engine clutch turns on, it may be checked through the accelerator pedal sensor (APS) whether or not the accelerator pedal is stepped on to a certain depth (predetermined value) or more (tip-in or tip-out) (S500).

Next, when a measured value obtained by a signal inputted from the accelerator pedal sensor (APS) is greater than a predetermined value, it may be determined whether or not it corresponds to the range of abnormal vibration occurrence (S600).

Here, the range of abnormal vibration occurrence may be the range, where abnormal vibration of the driving system can occur. Whether or not control according to various embodiments of the present invention is performed may depend on whether the current engine torque falls within the range of abnormal vibration occurrence.

For example, when the resonance rpm of the driving system is about 1800 rpm to about 2000 rpm with respect to the front wheel, and the boundary range (surrounding area of the inflection point of the two-step stiffness damper) is torque of about 240 Nm to about 290 Nm, since the abnormal vibration occurs in the above resonance rpm range of the driving system and the range of damper stiffness, the range of the abnormal vibration may be determined as the above resonance rpm range and the boundary range of damper stiffness (surrounding area of the inflection point).

When the current engine rpm and engine torque falls within the range of the predetermined rpm and determined torque (inflection point), the control according to various embodiments of the present invention may be performed by determining that abnormal vibration can occur. Otherwise, the control according to various embodiments of the present invention may be cancelled.

Next, when the vehicle-driving information such as current engine torque falls within the range of the abnormal vibration, it may be determined whether or not the current engine torque is greater than the predetermined torque (inflection point) (S700).

For example, it may be determined whether or not the current engine torque is greater than the predetermined torque of about 265 Nm.

Next, when the current engine torque is greater than the predetermined torque, the final torque may be allowed to become equal by increasing the engine torque (to the about 90% of the inflection point value), and reducing the motor torque (S810).

On the other hand, when the current engine torque is equal to or smaller than the predetermined torque, the final torque may be allowed to become equal by reducing the engine torque (to the about 110% of the inflection point value), and increasing the motor torque (S820).

In other words, the final driving torques when the current engine torque is greater than the predetermined torque and when the current engine torque is equal to or smaller than the predetermined torque are equal to each other.

After controlling correcting the engine torque and motor torque to each other, the control according to various embodiments of the present invention may end.

According to various embodiments of the present invention, the abnormal vibration can be prevented, and the continuity of total driving torque can be maintained by setting an abnormal vibration resonance rpm and a damper inflection torque and allowing the inflection point of damper to avoid the resonance point through mutual correction of the engine torque and motor torque when the engine torque passes the range of the abnormal vibration occurrence.

For convenience in explanation and accurate definition in the appended claims, the terms front and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for preventing an abnormal vibration of a hybrid vehicle, comprising:
sensing and inputting information into an engine management system (EMS) including an engine rpm, a transmission rpm, a gear shift, a signal of an accelerator pedal sensor (APS), and an engine torque;
determining whether or not a current engine rpm and a current engine torque fall within a predetermined rpm range and damper reflection torque range that is a range of abnormal vibration occurrence, respectively; and
mutually correcting the engine torque and a motor torque when the current engine torque falls within the range of the abnormal vibration occurrence;
wherein the abnormal vibration is prevented by avoiding an inflection point of a damper at a resonance point of a driving system while maintaining a total driving torque.

2. The method of claim 1, wherein the correcting of the engine torque and the motor torque comprises:
determining whether or not the current engine torque is equal to or greater than the predetermined damper inflection torque; and
reducing the motor torque and increasing the engine torque when the current engine torque is greater than the predetermined damper inflection torque, or reducing the engine torque and increasing the motor torque when the current engine torque is equal to or smaller than the predetermined damper inflection torque.
